(19) United States
(12) Patent Application Publication
(10) Pub. No.: US 2021/0141523 A1
(43) Pub. Date: May 13, 2021

(54) PLATFORM-INDEPENDENT USER INTERFACE SYSTEM

(71) Applicant: Home Box Office, Inc., New York, NY (US)

(72) Inventors: Brandon C. Furtwangler, Issaquah, WA (US); Tyler R. Furtwangler, Sammamish, WA (US); Brendan Joseph Clark, Seattle, WA (US); Steven N. Furtwangler, Okemos, MI (US); J. Jordan C. Parker, Seattle, WA (US); Nathan J. E. Furtwangler, Kirkland, WA (US)

(21) Appl. No.: 17/155,952

(22) Filed: Jan. 22, 2021

Related U.S. Application Data
(63) Continuation of application No. 14/843,780, filed on Sep. 2, 2015.
(60) Provisional application No. 62/046,099, filed on Sep. 4, 2014.

(51) Int. Cl. G06F 3/0484; G06F 3/0485; G06F 8/38; G06F 8/35

(52) U.S. Cl. CPC G06F 3/04847; G06F 8/35; G06F 8/38; G06F 3/0485

(57) ABSTRACT

The described technology is directed towards a platform-independent user interface (UI) system. Views and other objects at the platform-independent UI system level perform layout, scrolling, virtualization, styling, data binding via data models and/or readiness. Input handling and output to a display tree are also performed at this level. An abstraction layer processes the display tree into function calls to objects of the underlying platform to render visible output.

### CROSS-REFERENCE TO RELATED APPLICATION

This application is a continuation of co-pending U.S. patent application Ser. No. 14/843,780, filed Sep. 2, 2015, entitled “PLATFORM-INDEPENDENT USER INTERFACE SYSTEM,” which claims priority to U.S. provisional patent application Ser. No. 62/046,099, filed Sep. 4, 2014. The entireties of the aforementioned applications are hereby incorporated by reference herein.

### BACKGROUND

A user interface (UI) of a computer program, to be considered favorably by end users, needs to be appealing to those users, straightforward to use and consistent in its operation. Designing such a user interface can be a complex and tedious task, as there typically needs to be a large number of UI-related components that have to work together.

The problem is complicated by the various client platforms on which an application can be run. For example, the same general type of application program may be run on a browser platform, on a gaming/entertainment console platform, on a smartphone platform, on a tablet platform and so on. Each of these clients/device types themselves may have different platforms; for example, there are different smartphone platforms. Moreover, the same platform may have different UI-related design considerations, e.g., an application program running on a tablet device may be somewhat modified when presenting the UI on the device's relatively small screen versus when the tablet is plugged into and displaying the UI on a relatively large monitor (ten foot design).

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, the technology described herein is directed towards receiving, at a view, an instruction to draw a representation of the view to a display node tree. The view requests data from a model associated with the view, receives the requested data and applies style properties to process the data into styled data. The view draws, including outputting the styled data to the display node tree. Nodes in the display node tree may be processed at an abstraction layer into platform-dependent function calls to visibly render the tree.

Other advantages may become apparent from the following detailed description when taken in conjunction with the drawings.

### BRIEF DESCRIPTION OF THE DRAWINGS

The technology described herein is illustrated by way of example and not limited in the accompanying figures in which like reference numerals indicate similar elements and in which:

FIG. 1 is an example representation of a platform-independent user interface (UI) system including view and model objects, in which the platform-independent UI system operates above a platform UI, according to one or more example implementations.

FIG. 2 is an example representation of a view tree used by the UI system, according to one or more example implementations.

FIG. 3 is an example representation of the view tree of FIG. 2 may be rendered as output, according to one or more example implementations.

FIG. 4 is an example block diagram representing example components of a platform-independent UI system, according to one or more example implementations.

FIG. 5 is an example block diagram showing how models retrieve data for a view, according to one or more example implementations.

FIG. 6 is an example representation of how a view tree maps to a display tree, and to an underlying platform via an abstraction layer, according to one or more example implementations.

FIG. 7 is an example block diagram showing how a platform-independent UI system receives input, according to one or more example implementations.

FIG. 8 is an example representation of navigating among views via user interaction with menu items to obtain data and thereby take action (e.g., invoke a movie player), according to one or more example implementations.

FIG. 9 is a flow diagram showing example steps related to outputting a view, according to one or more example implementations.

FIG. 10 is a flow diagram showing example steps related to handling user interaction with respect to a view, according to one or more example implementations.

FIG. 11 is a block diagram representing an example computing environment into which aspects of the subject matter described herein may be incorporated.

### DETAILED DESCRIPTION

Various aspects of the technology described herein are generally directed towards a user interface (UI) system having a number of orchestrated objects that have roles and responsibilities with respect to outputting information to a user and receiving input from the user. For example, an application program UI designer may specify a number of view objects, arranged as a tree, that each may present visible UI elements to a user, directly and/or via child view objects. The user interacts with certain view objects that are invocable to receive input. In turn, an invoked view object performs some action, such as to navigate to a new location (e.g., another menu view object), change focus, play a movie, change a setting and so forth.

In one or more aspects, the UI components described herein perform relatively complex UI operations at a level that is above any particular underlying platform. Such operations include receiving input, retrieving data, visualizing the data according to a designer-specified layout and style, navigating among views, and so forth. For example, an element's position, scale, rotation, or any other styleable property is handled above the underlying platform, meaning that most of the UI code / objects can be reused across various platforms. This provides for an application program UI that is abstracted from the platform UI, whereby, for example, an application program's UI need only be designed once to be used on various platforms, with relatively little code needed to interface with any given platform (the underlying platform-dependent UI system), e.g., using the API calls/object interfaces and methods provided by that platform. For example, the platform-independent UI system may be used above various browsers' UI systems, smartphone/tablet UI systems, personal computer operating systems' UI systems, and so on.

As will be understood, at least some of the UI output may be data driven, in that how the UI information that is presented to a user (e.g., visually and/or audibly) depends on the data to be presented. For example, a navigable location to which the user may navigate is rendered based upon data bound to that location; e.g., a user may click on a button or the like that is data bound to a “menu page” type object, with data objects that appear on that menu page in turn being data bound by references in the menu page type object. As a more particular example, a “Movies” menu (an items / container view object) may display four invocable tile view objects (e.g., similar to selection buttons), with each tile bound to a particular set of data, such as corresponding to a “Popular” tile, a “Genre” tile, a “New Releases” tile and a “Select by Decades” tile. Without changing the “Movies” menu view object code and/or any links thereon, the underlying data to which the menu object is bound may be changed to instead provide a “Popular” tile, a “Genre” tile, a “New Releases” tile and a “More Options” tile. This provides a consistent way to present information to a user, and moreover, allows changes to the data to determine what the user sees (and/or hears), rather than, for example, changing code/links of a menu page as is conventionally done to change a UI.

It should be understood that any of the examples herein are non-limiting. For instance, some of the view objects described herein are exemplified with generally static visible properties such as child view positioning, borders and so forth for purposes of illustration. However in actual UIs, view objects may be animated over a number of rendering frames, may make state-based changes (e.g., to indicate having focus), may output audio, vibrations and so forth instead of or in addition to mostly static visible output. As such, the technology described herein is not limited to any particular embodiments, aspects, concepts, structures, functionalities or examples described herein. Rather, any of the embodiments, aspects, concepts, structures, functionalities or examples described herein are non-limiting, and the technology may be used various ways that provide benefits and advantages in computing and user interface technology in general.

FIG. 1 is a generalized, conceptual diagram showing various example components that may be used to implement aspects of the technology described herein. In general, input 102 is provided by a user (or possibly automation or the like) to a UI system 104 that is independent of any platform. In one or more example implementations, the platform-independent UI system 104 contains various objects that each have roles and responsibilities and cooperate with each other with respect to providing an interactive, visualized representation of an application program's UI elements. These include a navigation system 106, views 108 (view objects) that each correspond to one or more display nodes which are rendered as output 110, and models 112 (including view model objects and data model objects) that obtain/provide the data needed by the views 108. For example, the models 112 are coupled to data sources 114 such as web services, databases, data stores, the public internet, a private network and/or the like to fetch the data the views need; (models can also cache reusable data for efficiency).

In general and as described herein, the platform-independent UI system 104 performs most of the actual UI work, including handling input, retrieving data, generating output and so forth. The platform-independent UI system 104 arranges the appropriate output (display nodes) 110 with the appropriate data and commands (e.g., script) in generally the same way regardless of the underlying platform (client), whereby the platform-independent UI system 104 need not be changed for each platform and is thus reusable across platforms. Instead of rewriting an application program UI for each platform, a relatively small amount of code provides a platform abstraction layer 116 that interfaces with the underlying platform UI 118; as a result, the underlying platform UI 118 need not do any significant work in typical scenarios. Non-limiting examples of a suitable underlying platform UI 118 include those based upon iOS® design kit, Android™, Windows® (e.g., via XAML and WinJS controls), and browsers via DOM objects including canvas elements and or WebGL. With respect to browsers, the platform abstraction layer 116 may adjust for different browser vendors and/or versions, e.g., to attempt to optimize around different browser quirks, to operate more efficiently and/or the like.

Thus, a UI designer may put together an application program UI only once, with the UI as complex as desired. Note however that the designer is not limited to the exact same UI design for each platform, because view objects may be styled with different properties, (primarily visual properties such as color, size, animation and so on). Thus, for example, a designer may use one set of view style data for a personal computer browser and a different set of view style data for a smartphone platform, so as to provide a more appropriate user experience for each platform. Similarly, the application program running on a tablet device platform may have the same UI view and other objects, yet have the state determine the current style properties, e.g., so as to be styled differently when presenting the UI on the device's relatively small screen versus when the tablet is plugged into and displaying the UI on a relatively large monitor (ten foot design). Note that a view can be styled with transition sets, which determine how the view animates its display nodes as state(s) change, e.g., a view comes into view or exits a view, or receives focus, is hovered over, is selected, and so on.

In general, the views 108 perform a number of operations that make the UI designer's task consistent and straightforward. Non-limiting example view object operations include layout, scrolling, virtualization (e.g., creating only the subset of child views that are currently needed), styling to apply visual and other property values to views, rendering (including visible, audio, tactile, etc.), data binding via data models and readiness (e.g., unfolding once data requested asynchronously becomes available). Further a view handles input either within the view logic or by passing the input up to a parent.

Views are composable, in that a parent view may have one or more child views, which also may have child views, and so on. In general, this forms a tree of views 220 as generally represented in FIG. 2, in which certain parent views are containers for other child views, while some of the views (generally leaf nodes in the tree) are invocable to accept input.

In the simplified example of FIG. 2, a view host 222 is a parent to one or more top-level views 223 and 224; if desired, the top-level views 223 and 224 may communicate through the view host 222, e.g., to hand off common elements to each other, transition elements in and out in a coordinated manner, and so forth. The exemplified “Movies” view host 222 includes one or more models (view models and data models, as generally described herein) that obtain the data for the top-level views 223 and 224, e.g., identifying them as items view containers of a certain subset of items, (e.g., “New Releases” and “Popular”). In turn, data model(s) for the top-level views 223 and 224 identify their child views 226-229, that is, top-level view 223 has an invocable child view 226 such as a “Back” button and a child items view 227 and top-level view 224 has an invocable child view 228 such as a “Settings” button and a child items view 229.

The child items view 228 and 229 with corresponding data models each have children comprising sets of tiles 240(1)-240(m) and 242(1)-242(n). For example, tiles 240(1)-240(m) may each represent a newly released movie or television show, while the tiles 242(1)-242(n) may each represent a popular movie or television show. The data models for each tile may, for example, provide text and an image, such as a movie title text and a representative image (e.g., frame) of the movie, or the movie poster or the like. Note that some of the tiles (e.g., the tiles 240(2) and 242(2) “connected” by a dashed line in FIG. 2) may be generally the same child of two different parents, e.g. a tile instance or copy representing the same movie; the data may be the same, yet processed differently (by a different view model) and/or styled differently as desired in each view instance.

FIG. 3 shows how the view tree 220 may be rendered as UI elements to a user. For example, the view host 222 may be styled with a border and background rectangle 322 containing the text “Movies” at the top center thereof. Note that in an implementation in which the view host 222 is not rendered/styleable, the view host may simply have a top-level view object that serves this purpose, with the views 223 and 224 no longer being top-level view objects but instead being children to such a top-level parent view.

Based on each view's associated style and data model(s), the view 223 may be rendered to include a “Back” button 350 and a “New Releases” (vertical list) menu 323, with at least some of its child tiles therein, whereas the view 224 may be rendered with a “Settings” button 352 (e.g., to navigate to a Settings menu) and a “Popular” (grid) menu 324 with at least some of its child tiles visualized therein. In the example, not all of the child tiles fit in each set's respective menu, and thus scrolling and virtualization are used.

With respect to virtualization, in this example the “New Releases” menu and “Popular” menu provide scrolling, whereby only the child tiles that are currently scrolled into view need be instantiated as object instances, that is, virtualized, for rendering. The parent view objects (e.g., corresponding to the “New Releases” menu and “Popular” menu) provide the virtualization functionality. This avoids having to consume resources for (possibly many thousands of) tiles that are not yet in view, and may never be scrolled into view. Note, however that in one or more implementations, for efficient operation one or more data caches may be preemptively primed with at least some of the “off-screen” tiles' data, in anticipation of their future need. Similarly, at least some instantiated tiles scrolled out of view need not be virtualized away unless and until memory space is needed for other views, because of the possibility of the user scrolling them back into the menu.

Turning to additional details of one example implementation, FIG. 4 shows a number of example components of an environment 400 including a user interface (UI) system that provides the above structure and functionality. The UI system may be used, for example, for any application, including one for playing streaming video, and may be run on top of any underlying device/vendor platform by providing an abstraction layer or the like that transforms the platform-independent input and output to input and output that is appropriate for a particular platform.

In one or more implementations, such as in FIG. 4, a navigator object 401 is called by application startup code 402 to navigate to a root menu (visualized as a View object) corresponding to the startup location, e.g., “RootMenu” (or some representative variable value) is specified as the factory identifier (ID). To obtain this menu, the navigator object 401 calls a location factory 404 for this “RootMenu” location 405, (where in general, a factory is an object that knows how to return an instance of a particular requested object). A view host 407 is created via a ViewHostFactory 408 (called by the location 405) for hosting a view menu 409, in which the view menu 409 in turn is created by a ViewFactory 410. Thus, the view host 407 calls the view factory 410 to return the requested view 409, typically applying a style to the view, (e.g., color scheme, text size, animation and so forth), as specified by a designer of the view 409 from among a set of styles 411, and which also may be based on the factory ID for the particular requested view, which in this example is a menu (or items view). Note that the set of styles may be flattened for each view at loading time, rather than dynamically changing a view's associated style data at runtime.

In one or more implementations, styles are used by the view factory 410 to initialize the created objects' properties. The styles are associated with a factory ID, and can be configured per-client. The view host 407, if visualized, also may have a style applied thereto from the style set 411 via the ViewHostFactory 408.

In typical situations, the view 409 may need view-related data, which in turn may be dependent on data of a (data) model. Thus, a view model factory 420, view model provider 421 and view model 422 may be objects called by other objects of the system as represented in FIG. 4; in general, a provider is an object that knows how to retrieve (and if necessary) reformat information corresponding to a model. Similarly, a (data) model factory 424 creates a (data) provider 425 and its model interface 426. The provider 425 retrieves the needed data, e.g., from platform networking 430 that communicates with one or more services 432; (note that the view model provider 421 converts the data from the data provider 425 format to a format as needed by the view 409).

By way of example, the “RootMenu” view may contain other views, each comprising a button or other interactive component that when selected navigates the user to a different menu. Each of these buttons (views) may be associated with a navigation location (another view) to which the system navigates if that button is pressed. In turn, those other views have an associated data model that specifies its data, which may also include buttons associated with further navigation locations.

In one or more implementations, as generally represented in FIG. 5, In general, a view model comprises an interface 550 of a view model provider 554 implementation coupled to a view 552, and a data model comprises an interface 556 (coupled to the view model 550) of a data model provider 558, which communicates with one or more data sources such as the web service 560. The view 552 requests data from the view model via the interface 550, whose provider 554 may translate the request into one or more requests for the needed data from the data model interface 556. In turn the data model provider 558 knows how to obtain corresponding information from the data source such as the service 560, and returns the information to the view model, which may translate/reassemble the information back into the data format expected by the view 552. In one or more implementations, these requests are asynchronous so that the UI system continues to operate while awaiting data retrieval. Note further that caching may be used for efficiency.

Thus, a view model includes is an interface that defines the shape of the data used by a view such as the view 552. A view model provider 554 is an implementation of a view model that implements the view model interface 550. Note that in one implementation, a view model basically specifies what view data is needed, but does not care about the source of the data. Instead, the data provider 558 is an implementation of a data model (the data model implements a data model interface 556) that knows how to obtain the data from a data source, such as the web service 560.

A view model is thus different from a data model in that the corresponding view 552 defines the data shape, whereas services (such as the service 560) typically determine the shape of a data model. Note that for the same model, there may be (e.g., two) different view models for two different views bound to the same data model. The view model provider 554 is an implementation of a view model that acts as the “glue”/binding between a data model and the view/view model, adapting the model data to the format a view 552 specifies.

Returning to FIG. 4, to navigate to a location, a location factory 404 maps the name of a navigable location into a concrete type of location 405. The location factory 404 allows each client (a program/platform using the factory system) to be configured to have different concrete locations. The view host factory 408 is responsible for creating a view host 407 from a view host factoryId, and applying an appropriate view host style. For a given location, there can be multiple view hosts, e.g., because although different clients may share the same location/data (location), they may look different visually (e.g., a ten foot design versus a tablet design are typically different from each other). Further, for a single client, certain runtime conditions may dictate different views of the same location (e.g., Snap mode vs. Full mode vs. Fill mode are possible modes that determine how a view appears).

The view factory 410 is responsible for creating a view 409 from a view factory ID, and applying an appropriate view style. Note that one difference between a factory ID and a view type is that a single type (e.g., an ItemsView container object) can be used by multiple factory Id configurations, e.g., a list container can contain different menus each having a different factory ID, for example. A difference between a factory ID and an instance is that the system can stamp out multiple instances for the same factory ID. View factory configurations are basically prefabricated configurations of views.

The view model factory 420 is responsible for creating an instance of a view model provider 421 (which implements a view model interface 422) for a factory ID, given a model. The view model factory 420 decides which implementation of a view model interface to use (which view model provider 421).

The (data) model factory 424 is responsible for creating an instance of a provider 425 (which implements a model interface) for a factory ID, given a data ID. The model factory 424 decides which implementation of a model interface to use (which model provider 425). For example, a data provider knows how to retrieve its requested data from the network service 432.

A model may be considered an interface that defines the shape of the data used by the application program, and a provider is an implementation of a model. A model describes what the data is, not where it comes from. Models may have identifiers (IDs), which are used for caching. Creating a model is synchronous, but accessing it (apart from its ID) is asynchronous; e.g., model properties return promises. A data provider knows where to get the data that a model defines, and adapts the data that it gets from its upstream source to the format that the model specifies. There can be multiple different providers for the same model, if there are multiple places to get the data. It is common for providers to make calls out to the platform HTTP stack to request data from a web service, for example.

With respect to views, a View is a primary composable unit of UI, and a view may have one or more child views. A view has an associated DisplayNode (tree) 440 for visualizing the view, (as also generally represented in FIG. 6). Sub-nodes are typically created based on the view model data. The view typically creates/passes a view model derived from its own view model to child views. A view, if invocable, handles user input that is specific to the view. This sometimes results in a navigation via the Navigation Router 450, e.g., to a different view.

In this way, a container view, such as a menu containing buttons, may navigate via a button selection to other locations. The view is built with child views (such as its buttons or tiles), in which each view becomes a display node 440 in a display node tree. The tree is rendered to a user 441 (via platform rendering 442), whereby the user can interact with the view 409 via platform input 444, e.g., to a button device/button provider 446, 447 that is handled by an input manager 448. Interaction with the view 409 results in a navigation router 450 being invoked to navigate to a new location, e.g., another menu comprising a container view with a set of child views with which a user 441 may interact, and so on, e.g., to provide input 444 and to see a rendering 442 of the display nodes 440.

Note that although FIG. 4 shows a button device 446, other types of input are used in addition to button input. As described herein further with reference to FIG. 7, this includes pointer input (e.g., via a mouse or touch) and/or command input (e.g., via speech or advanced keyboard keys/key combinations that correspond to commands rather than buttons). In general, the platform input 444 (FIG. 4) is passed up to the platform-independent level and gets to a view via the input manager 448 and an associated input scope 449. Button input is routed to a view having focus, pointer input is routed to a view based upon hit testing, and command input is routed to a view (or set of views) that meets filtering criteria with respect to handling the type of command received and/or how that command was received (e.g., by speech versus a keyboard key combination).

Also shown in FIG. 4 is the ability for automated input, shown via automation 471, e.g., based upon an automation tree 472 or the like, to act as a virtual button device 473 (or other virtual input device). This may be used in testing, troubleshooting and so forth, for example, including via remote operation.

Among other functionality, the navigator 401 also maintains navigation breadcrumbs (a navigation stack of locations) so that users can navigate to previous locations. More particularly, the navigator 404 in conjunction with the location factory 406 creates locations upon navigation, and when navigating away from a location, the navigator 404 may save the location's state in a breadcrumb.

The NavigationRouter 450 is responsible for deciding a location to which to navigate, given a model and some additional context. It is common that a button is associated with some data, and when the button is clicked the system needs to navigate to a location that is determined by the type of data with which the button is associated (bound). This consolidates the logic. Such data-driven navigation provides numerous benefits, including that a change to the data results in a change to the program behavior, without needing to change the code and/or links on a page, for example.

As described herein, a location 405 represents a navigable (and potentially deep-linkable) location in the program code (e.g., application). The location is responsible for getting the data associated with this location, given some navigation arguments, and connecting the location to a ViewHost 407. Note that in one implementation, location does not know anything about the view 409, only the data, that is, the model(s). In general, a location is more portable than ViewHosts; e.g., different designs can be built off the same data.

The ViewHost 407 is responsible for creating the Views that visualize the model(s) provided by a location. The ViewHost 407 registers views that it can create or acquire via handoff. The ViewHost 407 also needs to be able to create a registered view if it is not handed off from the previous ViewHost, and needs to be able to identify and handoff a view if it was already created by the previous ViewHost 407. The ViewHost 407 knows about the intra-view relationships, and thereby is able to handle input data that cross the top-level view boundary.

FIG. 6 is an example of how the platform-independent UI system may work with a particular platform, which in this example is a browser having domain object model (DOM) tree 660. As set forth herein, a view tree 662 is composed of parent and child views. These views (those that are currently visualized) map to one or more display nodes in a display tree 664. In general the display nodes contain the rendering instructions/commands/data and the like that are processed by the abstraction layer into API calls to objects of the underlying platform, which in the example of FIG. is example comprise objects in the DOM tree 660. The DOM objects may be based upon HTML text elements and canvas elements (if HTML5 is available), for example. For example, an HTML element may handle a property like “position” using CSS (Cascading Style Sheet) transforms, while a Canvas element render may handle “position” using a pure JavaScript® object, or a Matrix object including scale/rotation.

Note that in general, a display tree contains data and script commands, whereby, for example, JavaScript®, can draw the display tree independently as an image and then cause the entire image to be rendered in a single canvas element; (however for efficiency subsets of the tree may be rendered into multiple canvas elements to avoid having to re-render the entire display tree for a small change such as a focus change that happens frequently). One other alternative for contemporary browser platforms may include WebGL (Web Graphics Library), a JavaScript® API that uses the graphics processing unit.

In iOS, well-documented UI kit classes (e.g., UIView) have methods that allow for drawing. The setNeedsDisplay or setNeedsDisplayInRect method of an iOS view object may be used to instruct a platform UIView object to redraw. Thus, updating is straightforward, e.g., by drawing a bitmap in JavaScript® and then outputting that bitmap to a UIView object.

In Android, well-documented APIs, classes and methods may be used to draw to a device's screen. These include a Rect class for creating a rectangle based upon size properties, a Paint class for text rendering with desired colors and styles, a Canvas class having methods for drawing a bitmap of pixels, a canvas to host the draw calls (writing into the bitmap), a drawing primitive (e.g. Rect, Path, text, Bitmap), and a paint (to describe the colors and styles for the drawing). A Matrix object may be used for transforming coordinates/scaling.

In general, because styling, layout, formatting and the like are performed at the platform-independent UI level by the UI system 104 (FIG. 1) via the view tree 662 and display tree 664, these underlying platform (e.g., DOM) objects are composed in a straightforward manner. The display tree 664 may act as the “ground truth” as to what an element's position, scale, rotation, or any other styleable property is currently set. This enables better performance, as queries for these values (e.g., from the view objects) can be answered without conferring with the web browser or native back end.

Leaving the platform-dependent details up to the platform abstraction layer implementation 116 (FIG. 1) provides significant flexibility. Each implementation can account for the quirks or limitations of the target platform, as well as leverage any advantages of the target platform.

Turning to various aspects related to input into the platform-independent UI system, in general, input may come from a number of input devices, such as the input devices 701-705 exemplified in FIG. 7. Input from such devices 701-705 is classified into a number of input types; in one or more implementations, this includes button input, pointer input and command input. A namespace component 706 or the like may be used to route input from the various input devices 701-705 to an appropriate provider 708-710 for that class/type of input. A general difference between input providers is based on how each type of input is intended to be used, how input events are organized/exposed, and what data each input event contains.

Each button device comprises a low-level source of button press events coming from a single physical button type device. Examples of button input, which may be handled by a button provider 708 (FIG. 7), include gamepad input (e.g., pressing the ‘A’ button on a game controller), keyboard (e.g., QWERTY) input, and media remote input (e.g., pressing a semantic button on a media remote control device, like the “Fast Forward” button). In general, the button provider 708 provides events when buttons are pressed, and aggregates multiple button devices (e.g., 701-703) into a single event stream for this class of input.

Mouse, touch, stylus, and gesture/skeletal input or the like are generally considered ‘pointer’ input that is processed by a pointer provider 709. Voice input, certain keyboard (e.g., Ctrl+S), and some media remote commands are considered ‘command’ input that is processed by command button provider 710. Although only one pointer class input device 704 and one command class input device are shown in FIG. 7, it is understood that any practical number of such input devices (or no such device/device class at all) may be present in a given scenario.

An input manager 712 aggregates the events from the input providers 708-710. In general, the input manager 712 maintains a stack of input scopes, and for example routes input events to the topmost input scope.

In general, for a button provider 708, button input is intended to be directed to the view with focus. Note that the platform itself typically has no notion of which application program UI element has focus. Instead, as represented in FIG. 7, in one or more implementations, when a user interacts with an input device 701, 702 and/or 703 and thereby the corresponding button provider 708, the input manager 712 in conjunction with an input scope, tracks this focus information for an application program. This ensures that any button input is routed to the focused view. For example, the input scope maintains a reference to the focused view, receives button input events from the input manager and routes the input events to the currently focused view. The view typically has an associated invoke handler for handling each input event, e.g., by taking some action based upon the event; (however if the view does not have an appropriate invoke handler, the view bubbles the event up to its parent view, and so on, until handled, e.g., along a focus chain).

Similarly, the input manager 712 along with an input scope may track which UI element is under the pointer, and another input scope to track which UI element or elements of the UI view tree are currently visible.

For the pointer provider, pointer input is intended to be directed to the UI element ‘under’ the pointer (via hit-testing). Again, the platform itself typically has no notion of UI elements and/or hit testing, except, for example, when platform-based scrolling is being used.

With respect to input corresponding to the command provider, command input is intended to be directed towards something on the screen, but not via focus or hit testing in one or more implementations. Command execution is a guided process that may contain a number of phases. Phases include waiting, in which the initial phase is waiting for the user to initiate commanding, and initiation.

The output of initiation comprises a list of command targets that has been filtered based on the known information (how the process of initiation began and/or the command). Note that at the time of initiation, a command may or may not yet be available.

By way of some examples, commanding can be initiated in various ways. For example, a user may say “Xbox” whereby there is no command available, or say “Xbox play” whereby a command is available, namely ‘Play’. (Note that the “®” symbol was not included in the Xbox®-related commands above, because a user does not refer to such a symbol when speaking such commands.)

Another way that a command may be initiated is when the user presses and/or holds ‘Ctrl’ or ‘Alt’ on the keyboard. When such a button is pressed alone there is no command available; however, if a user presses ‘Ctrl+S’ such as to initiate a ‘Save’ command, there is a command available. Another command may occur via some direct interaction, e.g., if a user presses ‘Play’ on a media remote control device, the ‘Play’ command is directly available.

When initialization does not contain a command, (e.g., saying “Xbox” versus pressing ‘Play’), the command provider goes into a targeting phase; (otherwise, this targeting phase is skipped). In the targeting phase, the user ordinarily sees some form of visualization that indicates which commands are available to execute. For example, when a user says “Xbox”, movie tiles may go into a command target visual state in which their title is highlighted. This indicates to the user that the user can then speak a particular movie title (or show title) to execute that particular tile activation command. Another example is when a user presses ‘Alt’ in Microsoft® Word, and the ribbon shows tool tips, e.g., to indicate to the user that further hitting ‘5’ will save the file.

Once the user specifies a command, the command target list is filtered. If the list length is greater than one, that is, more than one UI element still applies to the command, the process goes to a disambiguation phase to refine the selection. If instead the list length equals one, that is, one command applies, the process executes the command. If the list length is zero, the process stays in targeting. At some point the targeting phase may be canceled, e.g., either explicitly (such as ‘Esc’ or ‘cancel’) or implicitly (via a time timeout).

As described above, automation may provide input, wherein automation is a program that simulates a user, typically for testing purposes. Automation can interact with the application by injecting simulated input via virtual input devices (such as a VirtualButtonDevice). Automation also can “see” the application operations via event logging and an automation tree (e.g., a generally simplified, serializable version of the view tree). In addition to general testing scenarios, automation may be used for automated validation of user scenarios, crash/leak detection over long-haul usage, for debugging, and to provide spam input to find timing issues. Automation may be used for other desired purposes, e.g., to help a user and/or to provide automated input to a wizard or a series of menus to obtain a desired result and so on. A view can generate an automation peer.

FIG. 8 is an example of how a user may navigate among menus to select a movie to play, in which the labeled arrows represent a general ordering of some UI system operations. In general, at startup or via “Home” or “Back” interaction, the system visualizes a “Home” menu view 802 to the user. To determine the items on the “Home” menu view 802, at arrow one (1), the view 802 uses its models 804 (view model/provider and data model/provider) as described above; (the models' data source(s) are omitted in FIG. 8 for purposes of clarity). In response to its request for data, at arrow two (2) the “Home” menu view 802 gets data from which it displays a number of selection buttons (or tiles), e.g., including “Popular” “New Releases” “Genre” “Settings” and so on in this example.

User interaction (arrow three (3)) in this example selects the “Genre” menu view 806, whereby the UI system navigates to that menu, as described herein. To get the data to render the child views for this menu 806, the view 806 uses its models 808 (arrow four (4)), which in this example returns “Comedy” “Romance” “Action” “Adventure” and so on (arrow five (5)). The “Genre” menu view 806 uses this data to display these data as selections via corresponding selection buttons/tiles to the user.

Continuing with the example, consider that from the “Genre” menu view 806 that the user selects the “Action” button/tile (arrow six (6)), thereby navigating to an action menu 810, in which communication (arrows seven (7) and eight (8)) with its models 812 results in the action menu view 810 receiving data corresponding to a number of “Action” (action movie) tiles. Note that these are children of the action menu view 810, which based on the number of tiles and visible space for the action menu may choose/need to visualize only of subset of these tiles at a time, with user scrolling available to vary the visualized subset. These visualized children may retrieve any data (e.g., text and an image) to draw themselves via view and data models, (not shown in FIG. 8).

Further user interaction (arrow nine (9)) invokes one of the action tile views 814. In this example, the system directly navigates (arrow ten (10), without further user interaction) to a movie player view 818. The movie player view 818 communicates with its models 820 as represented by arrows eleven (11) and twelve (12) to start retrieving the streaming video content needed to play this movie, with additional communications performed as needed.

FIG. 9 summarizes how a view generally draws itself in one or more example implementations, beginning at step 902 where a view is instructed by its parent (or view host) to draw itself. Note that the UI unfolds “top-down” as views generally draw in the same manner, e.g., a parent draws, then instructs any children to draw over its drawing, and so on for their children, until leaf nodes are reached. An exception is that a parent view may have one or more “pre-children” that draw before the parent view, e.g., to provide a highlight or the like beneath the parent (in z-ordering) such as to visibly indicate when the parent view has focus.

In any event, to draw, a view needs its data to visualize. Assuming that in this example the view does not directly cache such data, the view requests the needed data from its view model at step 904. Note that a view such as a tile view may be an invocable view that needs data from more than one source, e.g., text data and image data as exemplified above, and thus may have more than one request for data, (although alternatively the text data and image data may be represented by respective child views of the tile view, which if invoked via interaction, pass the interaction-related information such as button ID up to the tile view).

Steps 906 and 908 represent the operations of the view model/provider and the data model/provider to obtain the data, which may be via a network data source, for example, or via a cache. In general, the data retrieval is asynchronous, whereby at step 910 the view gets back a promise for the data and registers for a callback instead of blocking. Note that as used herein, “promise” is a generic term representing any such asynchronous environment response, and for example may be related to, but is not limited to, a JavaScript® Promise. As also used herein, a promise is “fulfilled” when the corresponding data is returned (sometimes referred to as “resolving” or “binding” the promise in asynchronous programming environments).

The view may perform work while awaiting the data at step 912. For example, the view may make other data requests, communicate with its children, communicate with its parent and so on. A view may also draw itself as a “placeholder” (such as a blank or partially blank rectangle) while awaiting (at least some of) its data. For example, a user rapidly scrolling or paging through a menu containing a large number of items can continue do so without waiting for each full set of data to be received for each item view to fully draw. A subset of the items may be represented as placeholders that are only momentarily on screen, until the user reaches a stopping point and the full set of data for the currently visible subset of items is available to the views to fill in their respective placeholders. Note that requests for data made by views having placeholders that are no longer on screen may be canceled.

When the data is ready, the view gets a callback that fulfills the promise and the view prepares to draw itself based upon the data. As part of the drawing process, the view performs layout operations, applies styling properties to style the data (step 916), and draws itself by outputting to the display node tree (step 918). The view also instructs any appropriate child or children to draw. Note that at least some of the layout and styling may be done in advance of receiving the actual data, e.g., scale, position, size, rotation, color sometimes may be the same regardless of what data comes in; however, other times the view will determine at least some of the layout and styling properties based upon the data.

The UI thus unfolds the various views as the data becomes available, and the views are ready for interaction. Note that a view may enter an “Entering” state in which the view's style may provide some entering properties. For example, a view may animate by changing some properties over a number of rendering frames, e.g., to appear to have motion for awhile, to fade into view, and/or the like.

FIG. 10 is a flow diagram having example steps of how a view deals with interaction (step 1002), e.g., from a user input device (or via automation via a virtual input device). In the example of FIG. 10, consider that interaction with a view is only able to take one of three invoke actions, e.g., to navigate to a new location (e.g., a different menu location, or a movie player location and so on), to scroll its items, or to change the current interactive state of the view in some way; otherwise the view passes information regarding the interaction to its parent view.

With respect to interaction state changes of the view, example (non-limiting) interactive view states may include when a view is 1) focused (or not) within its input scope, 2) hovered over (the view has pointer input over it) or not, 3) listening (the view is listening for command input such as voice input and/or possibly gesture input) or not, 4) selected (the view is active/invoked/toggled on) or not, and/or 5) pressed (the view has either a pointer captured, or has the invoke button pressed) or not. Each of these view states may have a style property value subset associated therewith, e.g., so that a view's font may be one size when focused and another size when not focused, and so on. Thus, even though a style on a view may be static in that the style property values to be used for a given view may be fixed for a runtime session, the style property set appears to be dynamic by choosing which subset of the property values the view applies at any time, which may be based upon a current state within the variable states of a view.

If the interaction is a navigation-related action as evaluated at step 1004, e.g., the user has selected a different menu (from a “Genre” menu the user has selected “Comedy”), at step 1006 the view communicates with the navigation system (the NavigationRouter) to inform the navigation system of the new desired location. The view also informs the navigation system when a “Back” button or the like is selected, as the navigation system maintains information as to where to navigate back. The view then enters an “Exiting” state at step 1008 to exit as desired, e.g., to animate itself off screen/fade out, and so on. Note that a parent of the view, such as a view host or another view, may coordinate the handoff to the entering view as well as entering and exiting-related operations, e.g., the exiting view may leave UI elements for the entering view to use as desired, and any exiting and entering animations may be coordinated.

Another possibility is that the interaction is to scroll, e.g., to move items into and out of a view container's visible area, or to pan around within a view, such as to move around a street map. If scrolling at step 1010, step 1012 determines the scroll offset position and takes appropriate action, e.g., determines which child items to render within the view's visible area, and where to render them, or determines the X and Y panning offset. For scrolling child items, this typically includes virtualization by the view to determine which child items to create (which may be slightly more than those visible, e.g. to pre-populate child items in anticipation of their being needed) and which ones to virtualize away. The view then redraws based upon the changed scroll offset position at step 1020, which includes having any children redraw, e.g., those in the parent view's visible area.

If instead the interaction has changed the view's interaction state as evaluated at step 1014, (if not, in this example the view passes the interaction information up to its parent at step 1016), the view may select a different subset of style property values that match the changed interaction state at step 1018. For example, a view in the focused state may have a different background color than when not in the focused state. The view also may have any appropriate pre-child or pre-children draw based upon the changed interaction state before the view redraws. The view then redraws itself with the changed style property value(s) at step 1020. Once drawn, the view instructs any appropriate child or children to redraw, e.g., those currently visible (scrolled into view).

As can be seen, there is provided a platform-independent UI system in which the relatively complex UI operations are performed independent of the underlying platform. Such UI (non-limiting) operations may include layout, scrolling, virtualization, styling, data binding via data models and/or readiness. Input handling is another operation performed at the platform-independent UI level. Output (including visible, audio, tactile, etc.) to a display tree is performed at this level, which is processed by an abstraction layer into appropriate API calls to objects of the underlying platform.

One or more aspects are directed towards receiving, at a view, an instruction to draw a representation of the view to a display node tree. The view requests data from a model associated with the view, receives the requested data and applies style properties to process the data into styled data. The view draws, including outputting the styled data to the display node tree. Nodes in the display node tree may be processed into platform-dependent function calls.

Requesting the data from the model associated with the view may include communicating a request to a view model and receiving a promise in response to the request. Receiving the data from the model may include receiving the data from the view model to fulfill the request. The view model may communicate with a data model to obtain the data.

Further described herein is receiving input at the view, and taking action based upon the input. Taking the action may include communicating with a navigation system to navigate to a new location. The input received at the view may include receiving scroll input, and taking the action may include determining a scroll position. Taking the action may include changing an interaction state of the view, including changing at least one layout property and/or at least one styling property to indicate the interaction state change, and redrawing the view with the at least one property change.

Receiving the input at the view may include receiving button input from a button provider, receiving pointer input from a pointer provider or receiving command input from a command provider. Receiving the input at the view may include receiving input via automation.

The view may be exited. This may include providing information to a parent of the view, to transition out the view and transition in an entering view.

One or more aspects are directed towards a user interface system, including a navigation system that receives a request for a location, in which the location corresponds to a view. One or more factories provide objects based upon the location, in which the objects include the view, a view model associated with the view, and a data model associated with the view model. The view is coupled to the view model to request data, and the view model is coupled to the data model, which in turn is coupled to a data source to obtain information corresponding to the data. The data is returned to the view in response to the request based upon information returned from the data model to the view model. The view draws itself based upon the data, including to apply layout properties and style properties to the data, and to output to a display node tree. The display node tree may be coupled to a platform-dependent user interface system via an abstraction layer.

The system view may be coupled to one or more input providers to receive input. Example input providers may be a button provider, a pointer provider and a command provider.

The view may be an items view having child items, and the view may be configured to determine which child items to virtualize, and to instruct at least some of the child items that are to be virtualized to draw within a visible area of the view.

One or more aspects are directed towards styling a view based upon a set of style properties, and drawing the view based at least in part on the set of style properties and data. Upon detecting interaction with the view, the view determines whether the interaction is directed towards navigation, scrolling, or a view interaction state change. If the interaction is directed towards navigation, described is navigating to a new view. If the interaction is directed towards scrolling, a changed scroll offset position is determined, with the view and/or child items in the view redrawn based upon the changed scroll offset position. If the interaction is directed towards a view interaction state change, described is changing one or more style properties to provide a changed set of style properties and redrawing the view based at least in part on the changed set of style properties.

The view data may be retrieved via at least one model. For example, upon determining that the interaction is directed towards navigation, navigating to the new view may be based upon a location identified in the data.

Retrieving the data may include receiving a promise for the data from the at least one model, and later receiving the data to fulfill the promise.

The view may output to a display tree. The display tree is processed at an abstraction layer (with which the display tree interfaces) into method calls to one or more underlying platform objects.

### EXAMPLE COMPUTING DEVICE

The techniques described herein can be applied to any device or set of devices (machines) capable of running programs and processes. It can be understood, therefore, that personal computers, laptops, handheld, portable and other computing devices and computing objects of all kinds including cell phones, tablet/slate computers, gaming/entertainment consoles and the like are contemplated for use in connection with various implementations including those exemplified herein. Accordingly, the general purpose computing mechanism described below in FIG. 11 is but one example of a computing device.

Implementations can partly be implemented via an operating system, for use by a developer of services for a device or object, and/or included within application software that operates to perform one or more functional aspects of the various implementations described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 11 thus illustrates an example of a suitable computing system environment 1100 in which one or aspects of the implementations described herein can be implemented, although as made clear above, the computing system environment 1100 is only one example of a suitable computing environment and is not intended to suggest any limitation as to scope of use or functionality. In addition, the computing system environment 1100 is not intended to be interpreted as having any dependency relating to any one or combination of components illustrated in the example computing system environment 1100.

With reference to FIG. 11, an example device for implementing one or more implementations includes a general purpose computing device in the form of a computer 1110. Components of computer 1110 may include, but are not limited to, a processing unit 1120, a system memory 1130, and a system bus 1122 that couples various system components including the system memory to the processing unit 1120.

Computer 1110 typically includes a variety of machine (e.g., computer) readable media and can be any available media that can be accessed by a machine such as the computer 1110. The system memory 1130 may include computer storage media in the form of volatile and/or nonvolatile memory such as read only memory (ROM) and/or random access memory (RAM), and hard drive media, optical storage media, flash media, and so forth; as used herein, machine readable/computer readable storage media stores data that does not include transitory signals, (although other types of machine readable/computer readable media that is not storage media may). By way of example, and not limitation, system memory 1130 may also include an operating system, application programs, other program modules, and program data.

A user can enter commands and information into the computer 1110 through one or more input devices 1140. A monitor or other type of display device is also connected to the system bus 1122 via an interface, such as output interface 1150. In addition to a monitor, computers can also include other peripheral output devices such as speakers and a printer, which may be connected through output interface 1150.

The computer 1110 may operate in a networked or distributed environment using logical connections to one or more other remote computers, such as remote computer 1170. The remote computer 1170 may be a personal computer, a server, a router, a network PC, a peer device or other common network node, or any other remote media consumption or transmission device, and may include any or all of the elements described above relative to the computer 1110. The logical connections depicted in FIG. 11 include a network 1172, such as a local area network (LAN) or a wide area network (WAN), but may also include other networks/buses. Such networking environments are commonplace in homes, offices, enterprise-wide computer networks, intranets and the Internet.

As mentioned above, while example implementations have been described in connection with various computing devices and network architectures, the underlying concepts may be applied to any network system and any computing device or system in which it is desirable to implement such technology.

Also, there are multiple ways to implement the same or similar functionality, e.g., an appropriate API, tool kit, driver code, operating system, control, standalone or downloadable software object, etc., which enables applications and services to take advantage of the techniques provided herein. Thus, implementations herein are contemplated from the standpoint of an API (or other software object), as well as from a software or hardware object that implements one or more implementations as described herein. Thus, various implementations described herein can have aspects that are wholly in hardware, partly in hardware and partly in software, as well as wholly in software.

The word “example” is used herein to mean serving as an example, instance, or illustration. For the avoidance of doubt, the subject matter disclosed herein is not limited by such examples. In addition, any aspect or design described herein as “example” is not necessarily to be construed as preferred or advantageous over other aspects or designs, nor is it meant to preclude equivalent example structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the example systems described herein, methodologies that may be implemented in accordance with the described subject matter can also be appreciated with reference to the flowcharts/flow diagrams of the various figures. While for purposes of simplicity of explanation, the methodologies are shown and described as a series of blocks, it is to be understood and appreciated that the various implementations are not limited by the order of the blocks, as some blocks may occur in different orders and/or concurrently with other blocks from what is depicted and described herein. Where non-sequential, or branched, flow is illustrated via flowcharts/flow diagrams, it can be appreciated that various other branches, flow paths, and orders of the blocks, may be implemented which achieve the same or a similar result. Moreover, some illustrated blocks are optional in implementing the methodologies described herein.

### CONCLUSION

While the invention is susceptible to various modifications and alternative constructions, certain illustrated implementations thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the invention is not to be limited to any single implementation, but rather is to be construed in breadth, spirit and scope in accordance with the appended claims.

What is claimed is:

1. A system, comprising:
a processor; and
a memory that stores executable instructions that, when executed by the processor, facilitate performance of operations, the operations comprising:
receiving, by a user interface from a platform device, a request to render a navigable location of the computerized application, the request comprising an identifier;
in response to the request:
retrieving data associated with the navigable location;
creating a tree of view objects based on the retrieved data;
identifying style properties defined for the view objects based on the identifier; and
outputting a tree of display nodes that respectively corresponds to the tree of view objects, wherein the tree of display nodes contains instructions to render the view objects according to the style properties;
and
wherein the user interface is independent of application programming interface calls of the platform device, resulting in the user interface being compatible without change across different platform devices.

2. The system of claim 1, wherein the platform device comprises a smartphone, a tablet computing device, or a personal computer.

3. The system of claim 1, wherein the retrieving the data associated with the navigable location comprises communicating a request to a view model.

4. The system of claim 3, wherein the operations further comprise communicating from the view model to a data model to obtain the data.

5. The system of claim 1, wherein the operations further comprise receiving information corresponding to input received at a view object, and taking action based upon the information.

6. The system of claim 5, wherein taking the action comprises communicating with a navigation system to navigate to a location.

7. The system of claim 5, wherein receiving the information corresponds to receiving scroll input data, and wherein taking the action comprises determining a scroll position.

8. The system of claim 5, wherein taking the action comprises changing an interaction state of the view object.

9. The system of claim 1, wherein the operations further comprise processing, via an abstraction layer, one or more nodes in the tree of display nodes into one or more platform-dependent function calls that cause the platform device to visually render one or more of the view objects according to the style properties.

10. The system of claim 8, wherein the abstraction layer couples the user interface to a user interface system of a smartphone, a user interface system of a tablet computing device, or a user interface system of a personal computer operating system.

11. A system, comprising:
a processor that executes computer-executable components stored in a computer-readable memory, the computer-executable components comprising:
a user interface of a computerized application, wherein the user interface:
receives, from a platform device, a request to render a navigable location of the computerized application;
retrieves, without using any application programming interface (API) calls of the platform device, data associated with the navigable location;
creates, without using any API calls of the platform device, a tree of view objects based on the retrieved data;
identifies, without using any API calls of the platform device, style properties defined for the view objects based on an identifier in the request; and
outputs, without using any API calls of the platform device, a tree of display nodes that respectively corresponds to the tree of view objects, wherein the tree of display nodes contains instructions to render the view objects according to the style properties; and
wherein the user interface is compatible without change across different platform devices due to the user interface not using any API calls of the platform device.

12. The system of claim 11, wherein the computer-executable components further comprise an abstraction layer that converts the tree of display nodes into one or more API calls of the platform device, and wherein the platform device executes the one or more API calls to cause the platform device to visually render the view objects according to the style properties.

13. The system of claim 12, wherein the abstraction layer couples the user interface to a user interface system of a smartphone, a user interface system of a tablet computing device, or a user interface system of a personal computer operating system.

14. The system of claim 12, wherein the abstraction layer couples the user interface to a browser program running on the platform device.

15. A non-transitory machine-readable medium, comprising executable instructions that, when executed by a processor, facilitate performance of operations, the operations comprising:
receiving, by a user interface operatively coupled to a processor, a request from a platform device to render a navigable location of the computerized application;
retrieving, by the user interface and without using any application programming interface (API) calls of the platform device, data associated with the navigable location;
creating, by the user interface and without using any API calls of the platform device, a tree of view objects based on the retrieved data;
identifying, by the user interface and without using any API calls of the platform device, style properties defined for the view objects based on an identifier in the request;
outputting, by the user interface and without using any API calls of the platform device, a tree of display nodes that respectively corresponds to the tree of view objects, wherein the tree of display nodes contains instructions to render the view objects according to the style properties; and
wherein the user interface is compatible without change across different platform devices as a result of the user interface being independent of any API calls of the platform device.

16. The non-transitory machine-readable medium of claim 15, wherein the operations further comprise converting, by an abstraction layer operatively coupled to the processor, the tree of display nodes into one or more API calls of the platform device, wherein the platform device executes the one or more API calls to cause the platform device to visually render the view objects according to the style properties.

17. The non-transitory machine-readable medium of claim 16, wherein the converting by the abstraction layer comprises converting the tree of display nodes into one or more API calls of a user interface system of a smartphone.

18. The non-transitory machine-readable medium of claim 16, wherein the converting by the abstraction layer comprises converting the tree of display nodes into one or more API calls of a tablet computing device.

19. The non-transitory machine-readable medium of claim 16, wherein the converting by the abstraction layer comprises converting the tree of display nodes into one or more API calls of a personal computer operating system.

20. The non-transitory machine-readable medium of claim 16, wherein the converting by the abstraction layer comprises converting the tree of display nodes into one or more API calls of a browser program running on the platform device.
